(19) United States
(12) Patent Application Publication
(10) Pub. No.: US 2026/0202261 A1
(43) Pub. Date: Jul. 16, 2026

(54) EIS Measurement Apparatus, EIS-Based Busbar Temperature Detection Apparatus, Method Thereof

(71) Applicant: SK On Co., Ltd., Seoul (KR)

(72) Inventors: Kyu Min HWANG, Daejeon (KR); Yun Nyoung LEE, Daejeon (KR); Jae Hee LEE, Daejeon (KR); Hyun Jun LEE, Daejeon (KR); Ung JON, Daejeon (KR)

(21) Appl. No.: 19/440,890

(22) Filed: Jan. 6, 2026

(30) Foreign Application Priority Data
Jan. 13, 2025 (KR) 10-2025-0004746

(51) Int. Cl. G01K 7/18; H01M 10/42

(52) U.S. Cl. CPC G01K 7/18; H01M 10/4285; G01K 2217/00

(57) ABSTRACT

The present disclosure relates to an EIS measurement apparatus, and an apparatus and method for detecting a temperature of a busbar using EIS. According to an embodiment, a busbar temperature detection apparatus using EIS is an apparatus for detecting a temperature of a busbar formed between a plurality of cells or modules, and may include an EIS measurement unit configured to additionally assign an EIS measurement channel to the busbar and to measure impedance from an electrical signal applied to the busbar, a temperature estimation unit configured to estimate a temperature of the busbar based on the impedance measured by the EIS measurement unit, and an abnormality detection unit configured to detect an abnormal temperature of the busbar by comparing the temperature estimated by the temperature estimation unit with a preset reference temperature.

### CROSS-REFERENCE TO RELATED APPLICATION

This application claims priority to Korean Patent Application No. 10-2025-0004746 filed Jan. 13, 2025, the disclosure of which is hereby incorporated by reference in its entirety.

### BACKGROUND

### Technical Field

The present disclosure relates to an EIS measurement apparatus, and an apparatus and method for detecting a temperature of a busbar using EIS.

### Technical Considerations

In battery systems, particularly in electric vehicles or large-scale energy storage systems, a large amount of current needs to be transmitted efficiently, and for this purpose, a busbar is used.

A busbar is a conductor that transmits current between battery cells or modules, and is a conductive component in the form of a metal bar or strip capable of handling large currents.

When a large amount of current flows through such a busbar, corresponding heat generation occurs, and if the heat generation becomes excessive, the temperature of the busbar may rapidly increase, adversely affecting the stability of the battery system, and in severe cases, it may lead to dangerous situations such as thermal runaway.

Therefore, it is important to accurately monitor the temperature of the busbar and to immediately take action if the temperature increases excessively.

Conventionally, a temperature sensor is used to measure the temperature of a busbar.

However, as the number of busbars increases, attaching a temperature sensor to each busbar increases manufacturing costs and installation complexity, and also, fixed temperature sensors at various locations on the busbar may not reflect the accurate temperature of all busbars.

Furthermore, when a temperature sensor is attached to a specific location, it may only measure the temperature at that location. Therefore, a situation may occur where the sensor does not immediately detect overheating occurring in a specific section of the busbar, which limits the ability to promptly detect a temperature increase.

Furthermore, although the temperature may be indirectly estimated by fixing a temperature sensor adjacent to the busbar, the measurement reliability may decrease depending on the distance between the sensor location and the location where actual temperature measurement is needed, which may hinder accurate temperature monitoring.

### SUMMARY

Embodiments of the present disclosure may provide a busbar temperature detection apparatus and a method thereof, capable of assigning an EIS measurement channel to a busbar, measuring impedance of the busbar to estimate a temperature of the busbar, and detecting an abnormal temperature based on the estimated temperature.

Embodiments of the present disclosure may provide an EIS measurement apparatus capable of assigning a channel to each busbar through an EIS measurement channel electrically connected to the busbar, and measuring impedance of the busbar using the channel.

The busbar temperature detection apparatus and method using EIS and the EIS measurement apparatus according to the present disclosure may be widely applied in green technology fields such as electric vehicles, battery charging stations, and other applications using batteries like solar power generation and wind power generation.

Furthermore, the busbar temperature detection apparatus and method using EIS and the EIS measurement apparatus according to the present disclosure may be applied to eco-friendly electric vehicles, hybrid vehicles, and the like for preventing climate change by suppressing air pollution and greenhouse gas emissions.

According to an embodiment of the present disclosure, there is provided a busbar temperature detection apparatus using EIS, the apparatus comprising: an EIS measurement unit configured to assign an EIS measurement channel to a busbar formed between a plurality of cells or modules, and to measure impedance from an electrical signal applied to the busbar; a temperature estimation unit configured to estimate a temperature of the busbar based on the impedance measured by the EIS measurement unit; and an abnormality detection unit configured to detect an abnormal temperature of the busbar by comparing the temperature estimated by the temperature estimation unit with a preset reference temperature.

In some non-limiting embodiments, the EIS measurement unit may be configured to measure the impedance of the busbar by separating the impedance into a real part and an imaginary part, and the temperature estimation unit may be configured to estimate the temperature based on the real part.

In some non-limiting embodiments, the EIS measurement channel may be electrically connected to both ends of each busbar, and the EIS measurement unit may be configured to individually measure the impedance of each busbar through the EIS measurement channel.

In some non-limiting embodiments, the temperature estimation unit may be configured to estimate a temperature of a specific region within a battery system through the impedance measured from one or more busbars.

In some non-limiting embodiments, the temperature estimation unit may be configured to estimate the temperature based on the impedance by applying a Temperature Coefficient of Resistance according to a material of the busbar.

In some non-limiting embodiments, the abnormality detection unit may be configured to generate a warning signal when detecting a temperature exceeding the preset reference temperature.

In some non-limiting embodiments, the busbar temperature detection apparatus may be configured to monitor respective temperature data for one or more busbars in real time, and diagnose an overall thermal state of a battery system.

According to another embodiment of the present disclosure, there is provided a method for detecting a busbar temperature using EIS, the method comprising: assigning, by an EIS measurement unit, an EIS measurement channel to a busbar formed between a plurality of cells or modules, and measuring impedance of the busbar from an electrical signal applied to the busbar; estimating, by a temperature estimation unit, a temperature of the busbar based on the measured impedance; and detecting, by an abnormality detection unit, an abnormal temperature of the busbar by comparing the estimated temperature with a preset reference temperature.

In some non-limiting embodiments, the measuring the impedance of the busbar may comprise measuring the impedance by separating the impedance into a real part and an imaginary part, and the estimating the temperature may comprise estimating the temperature based on the real part.

In some non-limiting embodiments, the measuring the impedance of the busbar may comprise the EIS measurement channel being electrically connected to both ends of each busbar, and individually measuring the impedance of each busbar.

In some non-limiting embodiments, the estimating the temperature may comprise estimating a temperature of a specific region within a battery system by measuring the impedance from one or more busbars by the EIS measurement unit.

In some non-limiting embodiments, the estimating the temperature of the busbar may comprise estimating the temperature based on the impedance by applying a Temperature Coefficient of Resistance according to a material of the busbar.

In some non-limiting embodiments, the detecting the abnormal temperature of the busbar may comprise generating a warning signal when a temperature exceeding the preset reference temperature is detected.

In some non-limiting embodiments, the method for detecting a busbar temperature using EIS may monitor respective temperature data for one or more busbars in real time, and diagnose an overall thermal state of a battery system.

According to yet another embodiment of the present disclosure, there is provided an EIS measurement apparatus, the apparatus comprising: a channel assignment unit configured to assign an EIS measurement channel corresponding to one or more busbars formed between a plurality of cells or modules; and an EIS measurement unit configured to measure impedance of the busbar using an electrical signal applied to the busbar.

In some non-limiting embodiments, the one or more busbars may comprise a plurality of busbars, and the EIS measurement channel may be electrically connected to both ends of each of the plurality of busbars to measure the impedance of the plurality of busbars simultaneously or individually.

In some non-limiting embodiments, the EIS measurement unit may be configured to measure the impedance of the busbar by separating the impedance into a real part and an imaginary part, and estimate a temperature of the busbar based on the real part.

In some non-limiting embodiments, the EIS measurement unit may be configured to estimate a temperature based on the impedance by applying a Temperature Coefficient of Resistance according to a material of the busbar.

In some non-limiting embodiments, the EIS measurement apparatus may be configured to diagnose an overall thermal state of a battery system by analyzing the impedance measured from the one or more busbars.

In some non-limiting embodiments, an EIS measurement apparatus, and an apparatus and method for detecting a busbar temperature using EIS may be provided.

In some non-limiting embodiments, a temperature of a busbar may be estimated through impedance measurement of the busbar by assigning an EIS measurement channel to the busbar, and based on this, an abnormal temperature of the busbar may be detected.

In some non-limiting embodiments, impedance of a busbar may be measured by assigning a channel to the busbar, and through this, a state of the busbar may be diagnosed.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram illustrating a busbar temperature detection apparatus using EIS according to an embodiment of the present disclosure.

FIG. 2 is a flowchart explaining a method for detecting a busbar temperature using EIS according to an embodiment of the present disclosure.

FIG. 3 is a schematic diagram illustrating an example where an EIS measurement channel is additionally assigned to a busbar in a method for detecting a busbar temperature using EIS according to an embodiment of the present disclosure.

FIG. 4 is a schematic diagram illustrating the correlation between temperature and resistance (the real part of impedance) (a Nyquist plot) according to an embodiment of the present disclosure.

FIG. 5 is a diagram illustrating an electric vehicle applying a method for detecting a busbar temperature using EIS and including or using a busbar temperature detection system according to an embodiment of the present disclosure.

### DETAILED DESCRIPTION

Hereinafter, embodiments or aspects will be described in detail with reference to the accompanying drawings. However, since various changes may be made in the embodiments or aspects, the scope of the patent disclosure is not limited or restricted by these embodiments or aspects. It should be understood that all modifications, equivalents, and alternatives for the embodiments or aspects are comprised in the scope of the present disclosure. For example, it is to be understood that the present disclosure may assume various alternative variations and step sequences, except where expressly specified to the contrary. It is also to be understood that the specific devices and processes illustrated in the attached drawings, and described in the following detailed description, are simply exemplary and non-limiting embodiments or aspects of the disclosed subject matter. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “comprise”, “comprises”, “comprising”, “include”, “includes”, “including”, “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

It will be understood that when a component is described to as being “connected,” “combined” or “coupled” to another component, the component may be directly connected or coupled to the another component, but it may be “connected,” “combined” or “coupled” to the another component by an intervening another component that may be present.

Further, in describing the components of the embodiment or aspect, the meaning of “or” may mean each of the components, may mean two or more of the components, or may mean all of the components. For example, it should be understood that the expressions “a, b or c” represent any one of “a,” “b,” “c,” “a and b,” “a and c,” “b and c,” and “a, b and c.”

Components comprised in one embodiment or aspect and components comprising common functions will be described using the same names in other embodiments or aspects. The description given in one embodiment or aspect may be applied to other embodiments or aspects, and therefore will not be described in detail within the overlapping range, unless there is a description opposite thereto.

The device and/or ‘data’ processed by the device may be expressed in terms of ‘information”. Here, the information may be used as a concept comprising the data.

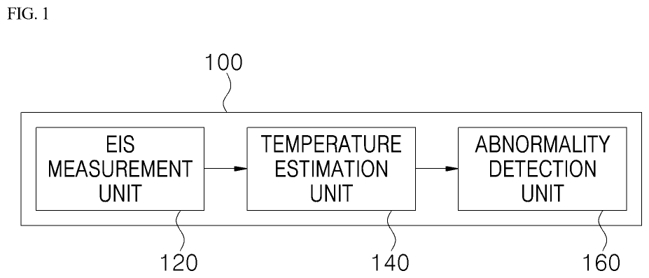

FIG. 1 is a diagram illustrating a busbar temperature detection apparatus using EIS according to an embodiment of the present disclosure.

Referring to FIG. 1, a busbar temperature detection apparatus using EIS according to an embodiment of the present disclosure is an apparatus for detecting a temperature of a busbar formed between a plurality of cells or modules. The apparatus may include an EIS measurement unit 120, a temperature estimation unit 140, and an abnormality detection unit 160. The EIS measurement unit 120 is configured to additionally assign an EIS measurement channel to the busbar and to measure impedance from an electrical signal applied to the busbar. The temperature estimation unit 140 is configured to estimate the temperature of the busbar based on the impedance measured by the EIS measurement unit 120. The abnormality detection unit 160 is configured to detect an abnormal temperature of the busbar by comparing the temperature estimated by the temperature estimation unit 140 with a preset reference temperature.

According to an embodiment of the present disclosure, by measuring the EIS of a busbar to estimate the temperature of the busbar and detect an abnormal state, an EIS measurement channel is additionally assigned to a busbar formed between a plurality of cells or modules in a battery system to estimate the temperature through impedance measurement of the busbar, and based on this, an abnormal temperature of the busbar is detected.

In the present disclosure, a busbar is formed between a plurality of cells or modules, is a conductor that transmits current within a battery system, enables electrical connection between cells or between modules, and transmits current generated in each cell to other components within the system.

When current flows through the busbar, it generates heat due to electrical resistance, and particularly when high current flows, a heat generation problem can occur, so monitoring the temperature of the busbar is required to maintain the stability of the system.

A busbar may be made of a metal with high electrical conductivity, such as copper or aluminum, and the Temperature Coefficient of Resistance (TCR) varies depending on the material. This coefficient may be used to describe the variation of resistance value with temperature change.

As such, since the thermal state of the busbar can affect the entire system, the impedance of the busbar is measured using EIS, and through this, the temperature is intended to be estimated.

The EIS measurement unit 120 according to an embodiment of the present disclosure may additionally assign an EIS measurement channel to the busbar and measure impedance through the EIS measurement channel from an electrical signal applied to the busbar. In this case, the electrical signal may be applied through an external path, for example, a loop including a module or a loop including a pack, but is not limited thereto. That is, the EIS measurement unit 120 additionally assigns an EIS measurement channel to a busbar formed between a plurality of cells or modules, and measures impedance through each channel from an electrical signal applied to the busbar.

In the present disclosure, “to assign an EIS measurement channel” to a busbar means to associate an EIS measurement channel with each of a plurality of busbars, wherein the EIS measurement channel is electrically connected to both ends of a respective busbar. That is, the channel assignment unit designates each busbar to be electrically connected to a different EIS measurement channel, thereby enabling the EIS measurement unit 120 to independently measure the impedance of each busbar. Such “assignment” may mean the act of associating an electrical path connecting the busbar and the EIS measurement unit to a specific busbar.

In the present disclosure, the expressions ‘to assign an EIS measurement channel’ to a busbar and ‘to electrically connect an EIS measurement channel to both ends of the busbar’ are used interchangeably as appropriate in the context and can be interpreted as having the same meaning.

In the present disclosure, a “channel” refers to an electrical path that is electrically connected to both ends of each of a plurality of busbars, and through which current and voltage signals for impedance measurement are applied or detected. That is, a “channel” may refer to an electrical connection path that enables impedance measurement between a busbar and the EIS measurement unit 120.

The EIS measurement unit 120 may acquire respective data by separating the impedance of the busbar into a real part and an imaginary part. The real part of the impedance mainly reflects the resistance component, and through this, the temperature of the busbar may be estimated. The imaginary part of the impedance represents an inductive or capacitive component.

According to an embodiment of the present disclosure, by assigning an EIS measurement channel to a busbar by the EIS measurement unit 120, the EIS measurement unit 120 is electrically connected to both ends of each busbar and may individually measure the impedance for each busbar. Through this, according to the present disclosure, the thermal state of a part or the entirety of the system may be determined by independently and individually measuring the impedance for one or more busbars.

The temperature estimation unit 140 according to an embodiment of the present disclosure may estimate the temperature of the busbar based on the impedance measured by the EIS measurement unit 120.

According to an embodiment of the present disclosure, the temperature estimation unit 140 estimates the temperature of the busbar based on the real part of the impedance, and can more accurately estimate the temperature by applying the Temperature Coefficient of Resistance according to the material. This may be achieved by a method of converting impedance to temperature using a formula that reflects the temperature change characteristics of resistance according to the busbar material.

The abnormality detection unit 160 according to an embodiment of the present disclosure may detect an abnormal temperature of the busbar by comparing the temperature estimated by the temperature estimation unit 140 with a preset reference temperature.

The abnormality detection unit 160 according to an embodiment of the present disclosure may determine whether an abnormal temperature has occurred by comparing the temperature of the busbar estimated by the temperature estimation unit 140 with a preset reference temperature. If the estimated temperature exceeds the reference temperature, it generates a warning signal to immediately notify of an abnormal state of the battery system. This may serve to detect and prevent overheating problems that may occur in the battery system in advance.

In one embodiment, in a structure where a plurality of cells or modules are interconnected within a battery system, an EIS measurement channel is assigned to each busbar, and the EIS measurement unit 120 applies an electrical signal to both ends of each busbar and measures the impedance therefrom. The temperature estimation unit 140 estimates the temperature of each busbar based on the measured real part of the impedance, and the abnormality detection unit 160 generates a warning signal upon a temperature exceedance by comparing the estimated temperature with a reference temperature.

Furthermore, the EIS measurement unit 120 additionally assigns an EIS measurement channel to one busbar and measures the impedance at both ends of the corresponding busbar. The temperature estimation unit 140 estimates the temperature of the corresponding busbar based on the impedance, and the abnormality detection unit 160 generates a warning signal if the temperature rapidly increases by comparing the estimated temperature with a reference temperature. This method is also applicable when monitoring a plurality of busbars individually.

Furthermore, after the EIS measurement unit 120 collects impedance through EIS measurements from one or more busbars, the temperature estimation unit 140 may estimate the temperature of a specific region within the system. For example, the thermal state of the corresponding region is determined through the impedance measured from a specific busbar by the EIS measurement unit 120, and the abnormality detection unit 160 can detect a thermal problem of the entire system in advance and generate a warning signal based on this data.

As such, according to an embodiment of the present disclosure, system costs can be reduced by directly estimating the busbar temperature through impedance measurement using EIS, without the need to attach a temperature sensor to each busbar as was done in conventional methods.

Furthermore, the temperature can be monitored in real time for a plurality of busbars through EIS measurement, and through this, the thermal state of the battery system can be diagnosed in real time.

Furthermore, by providing accurate temperature estimation based on the real part of the impedance and material properties in the temperature estimation unit 140, problems such as thermal runaway occurring within the battery system can be detected in advance.

Furthermore, the abnormality detection unit 160 generates an immediate warning signal when an abnormal temperature exceeding a reference temperature occurs, thereby ensuring the safety of the system and preventing accidents due to thermal problems.

Furthermore, the EIS measurement unit 120 can assign individual EIS channels for a plurality of busbars, and the temperature of each busbar can be independently estimated by the temperature estimation unit 240 to comprehensively monitor the state of the entire system.

According to an embodiment of the present disclosure, the EIS measurement unit 120 may measure the impedance of the busbar by separating it into a real part and an imaginary part, and the temperature estimation unit 140 may estimate the temperature based on the real part.

The EIS measurement unit 120 according to an embodiment of the present disclosure may measure the impedance from an electrical signal applied to the busbar, and measure it by separating it into a real part and an imaginary part. At this time, the real part represents the resistance component of the impedance, and the imaginary part represents the inductive or capacitive component.

The real part is important data that reflects the resistance characteristics of the busbar, reacts sensitively to temperature changes, and as the temperature of the busbar increases, the resistance component increases, so the temperature estimation unit 140 may estimate the temperature based on the real part. The imaginary part can reflect factors related to the inductance or capacitance of the busbar.

The real part according to an embodiment of the present disclosure reflects the material properties of the busbar and the change in resistance value according to temperature change, and can be used in the temperature estimation unit 140. The real part measured by the EIS measurement unit 120 can be utilized for temperature estimation based on the correlation with temperature.

Specifically, an EIS measurement channel is connected to both ends of the busbar by the EIS measurement unit 120, an electrical signal is applied, and the EIS measurement unit 120 acquires data by separating the impedance into a real part and an imaginary part. The temperature estimation unit 140 estimates the temperature of the busbar based on the real part, and can detect an abnormal temperature by comparing this with a preset reference temperature.

Furthermore, the real part measured from a specific busbar can be used by the temperature estimation unit 140 to estimate the temperature by applying the Temperature Coefficient of Resistance. This data is collected in real time, and the abnormality detection unit 160 can detect a temperature abnormality and generate a warning signal by comparing the estimated temperature with a reference temperature.

According to an embodiment of the present disclosure, the EIS measurement channel may be electrically connected to both ends of each busbar, and the EIS measurement unit 120 may individually measure the impedance of each busbar through the EIS measurement channel.

In a battery system, busbars formed between a plurality of cells or modules play an important role in current transmission, and the temperature change of each busbar can be closely related to the thermal state of the battery system.

The EIS measurement channel according to an embodiment of the present disclosure, by being electrically connected to both ends of each busbar, allows the impedance of each busbar to be independently measured by the EIS measurement unit 120. Through this, the busbar temperature detection apparatus according to an embodiment of the present disclosure may individually monitor the thermal state of each busbar, and temperature diagnosis across the entire system may be possible.

According to an embodiment of the present disclosure, each busbar can be located at various positions within the battery system, and the thermal state can also be different. By performing an independent measurement on each busbar using an EIS measurement channel, a thermal problem occurring in a specific region of the system may be quickly detected.

That is, the EIS measurement unit may accurately determine the state of each busbar through individual impedance measurement via the EIS measurement channel, and may identify an abnormal heat generation when it occurs in a specific busbar.

Specifically, for busbars formed between a plurality of cells or modules in a battery system, separately assigned EIS measurement channels are electrically connected to both ends of each busbar. The impedance of the busbar may be individually measured through each channel, and the temperature estimation unit 140 may estimate the temperature based on the real part of the impedance obtained from each busbar. The abnormality detection unit 160 can detect an abnormal temperature and generate a warning signal by comparing the temperature of each busbar with a reference temperature.

Furthermore, to simultaneously monitor a plurality of busbars in a specific battery system, independent EIS measurement channels can be assigned and electrically connected to each busbar. This allows the busbar temperature detection apparatus according to an embodiment of the present disclosure to monitor the thermal state of individual busbars in real time, and to track temperature changes according to the thermal characteristics of each busbar.

As such, according to an embodiment of the present disclosure, by having the EIS measurement channel electrically connected to both ends of each busbar by the EIS measurement unit, individual impedance measurement becomes possible, which can improve the accuracy and reliability of busbar temperature detection. Through this, the overall thermal state of the battery system can be monitored in real time, and there is an advantage of being able to respond quickly upon detection of abnormal heat generation.

Furthermore, the busbar temperature detection apparatus according to an embodiment of the present disclosure may independently manage the temperature change of each busbar through the monitoring of individual busbars, and may enhance the stability and efficiency of the system by providing more accurate temperature diagnosis.

According to an embodiment of the present disclosure, the temperature estimation unit 140 may estimate the temperature of a specific region within the battery system through the impedance measured from one or more busbars.

According to an embodiment of the present disclosure, after the EIS measurement unit 120 measures the impedance from one or more busbars through the EIS measurement channel, the temperature of a specific region within the battery system may be estimated based on the measured impedance. This allows for a more precise analysis of the temperature change in the region where the busbar is located and the thermal state of the system.

According to an embodiment of the present disclosure, a specific region may refer to a battery cell or module to which a busbar is connected within the battery system, or a section including several cells or modules, and this region may be a place that plays an important role in monitoring the thermal state at a specific location.

According to an embodiment of the present disclosure, the impedance measured from one or more busbars not only provides temperature information of the busbar itself but also allows for determining the comprehensive thermal state of a specific region. In particular, the EIS measurement unit 120 collects data from a plurality of busbars through the EIS measurement channel, and by processing this in the temperature estimation unit 140, the temperature of the specific region where the busbar is located can be estimated.

That is, the impedance measured from a plurality of busbars may also reflect the overall thermal state of the region to which the busbars belong. This data enables the temperature estimation unit 140 to estimate the temperature for each region by considering material properties, resistance changes with temperature, and the like.

Specifically, the EIS measurement unit 120 measures the impedance of each of a plurality of busbars located in a specific region within the battery system through the EIS measurement channel and transmits it to the temperature estimation unit 140. The temperature estimation unit 140 comprehensively estimates the temperature of the corresponding region by analyzing the real part of each busbar. In this process, if the temperature change of a specific region exceeds a reference value, the abnormality detection unit 160 generates a warning signal.

Furthermore, when one or more busbars in a specific battery system are located in a specific region within a battery module, the EIS measurement unit 120 collects impedance through the EIS measurement channel. The temperature estimation unit 140 determines whether a temperature of the corresponding area has increased based on this data, and through this, diagnoses the thermal state of the entire system.

As such, the busbar temperature detection apparatus according to an embodiment of the present disclosure may more accurately monitor the thermal state of a specific section within the system by estimating the temperature of a specific region through the impedance measured from one or more busbars. Accordingly, the busbar temperature detection apparatus according to an embodiment of the present disclosure may quickly detect local thermal problems, thereby ensuring the safety of the system.

That is, the busbar temperature detection apparatus according to an embodiment of the present disclosure may track the temperature of the section where each busbar is located in real time through specific region monitoring, detect temperature abnormalities in advance, and identify heat concentration areas within the system through data collected from a plurality of busbars to take efficient cooling or heat dissipation measures.

The temperature estimation unit 140 according to an embodiment of the present disclosure may estimate the temperature based on the impedance by applying the Temperature Coefficient of Resistance of the busbar material.

The Temperature Coefficient of Resistance (TCR) is a value that describes the characteristic change in a material's resistance with temperature, varies depending on the busbar material, and generally, resistance increases as temperature rises. The temperature estimation unit 140 estimates the temperature of the busbar by applying this Temperature Coefficient of Resistance to the impedance.

That is, the impedance measured by the EIS measurement unit 120 includes a resistance value that changes with temperature, and this is combined with the Temperature Coefficient of Resistance of the material to calculate the temperature.

The real part of the impedance represents the resistance component, and this data reacts sensitively to temperature changes. The temperature estimation unit 140 may accurately estimate the temperature of the busbar by applying the Temperature Coefficient of Resistance to the real part of the impedance obtained from the EIS measurement unit 120.

The Temperature Coefficient of Resistance of the material reflects the material properties of each busbar and is a numerical value of how much the resistance changes when the temperature rises.

The temperature estimation unit 140 according to an embodiment of the present disclosure applies this coefficient to analyze how the real part of the impedance reflects temperature changes, thereby enabling accurate temperature estimation.

Equation 1 below is for deriving a temperature estimation formula that estimates temperature from a resistance value, and the temperature of the busbar may be estimated based on the change in resistance according to the temperature change of the conductor.

R=R_ref[1+α(T−T_ref)] <Equation 1>
R: Resistance of the conductor at a specific temperature.
R_ ref: Resistance of the conductor at a reference temperature (usually 20° C.).
α: Temperature Coefficient of Resistance (TCR) of the conductor material.
T: Actual temperature of the conductor (value to be estimated).
T_ref: Reference temperature.

Equation 1 above reflects the temperature dependence of resistance to estimate the temperature of the busbar, and the actual temperature (T) can be estimated when the resistance component of the busbar (real part of impedance) is measured and the temperature coefficient of the material (α) and the reference resistance value (R_ref) are known.

By rearranging this Equation 1, a temperature estimation formula can be expressed as Equation 2 below.

T=(1/α)×[(R/R_ref)−1]+T_ref <Equation 2>

From Equation 2 above, the temperature of the busbar can be estimated based on the real part of the impedance.

According to an embodiment of the present disclosure, the EIS measurement unit 120 applies an electrical signal to both ends of the busbar and measures the impedance through an EIS measurement. At this time, the real part of the impedance reflects the resistance component, and using this, the temperature estimation unit 140 estimates the temperature.

Then, the EIS measurement unit 120 measures the real part separated from the measured impedance, and using this, the temperature estimation unit 140 estimates the actual temperature. According to Equation 2 above, the reference temperature (T_ref) and the Temperature Coefficient of Resistance (α) are input, and the temperature (T) is calculated by comparing with the reference resistance (R_ref).

The estimated temperature is compared with a reference temperature, and if the estimated temperature exceeds the reference, the abnormality detection unit 160 generates a warning signal to maintain the safety of the system.

Specifically, the EIS measurement unit 120 measures the real part of the busbar's impedance, and the temperature estimation unit 140 estimates the temperature of the busbar by applying the Temperature Coefficient of Resistance based on this data. For example, a busbar made of a material such as copper has a specific Temperature Coefficient of Resistance, and its resistance increases as the temperature rises. The temperature estimation unit 140 can perform an accurate temperature estimation by reflecting these material properties.

As such, the temperature estimation unit 140 according to an embodiment of the present disclosure applies the Temperature Coefficient of Resistance according to the material to estimate the temperature based on impedance, thereby enabling accurate and reliable temperature measurement. Through this, the temperature change of each busbar in the battery system can be determined in real time, and the thermal state of a busbar made of a material sensitive to temperature changes can also be accurately diagnosed.

Furthermore, the temperature estimation by applying the Temperature Coefficient of Resistance by the temperature estimation unit 140 enables more accurate temperature estimation suitable for the material of each busbar, and through this, the overall thermal state of the system can be managed more reliably.

Accordingly, the busbar temperature detection apparatus according to an embodiment of the present disclosure can detect thermal problems in the system in advance through accurate temperature diagnosis, and ensure the safety of the battery system by generating a warning signal.

The abnormality detection unit 160 according to an embodiment of the present disclosure may generate a warning signal if it detects a temperature exceeding a preset reference temperature.

The abnormality detection unit 160 according to an embodiment of the present disclosure plays a role in generating a warning signal when the temperature of the busbar estimated by the temperature estimation unit 140 is compared with a preset reference temperature and the temperature exceeds the reference temperature. The reference temperature refers to the maximum temperature that should be safely maintained in the system and serves as an important criterion for detecting heat generation issues within the battery system.

That is, the reference temperature is preset according to the system operating conditions, is compared with the real-time temperature calculated by the temperature estimation unit 140, and the abnormality detection unit 160 may detect a temperature abnormal state through this comparison process and generate a warning signal if necessary.

According to an embodiment of the present disclosure, if the estimated temperature exceeds the reference temperature, the abnormality detection unit 160 may immediately generate a warning signal. This warning signal is transmitted to the BMS (Battery Management System) or a user interface, allowing a user to recognize an abnormal temperature state occurring within the battery system.

The warning signal may be delivered in the form of a visual, audible, or electronic notification. For example, a warning message may be output through an LED display in the system, or an alarm sound may be generated. Such warnings help to detect overheating problems in the system early and induce necessary actions to be taken.

Specifically, the EIS measurement unit 120 measures the impedance from the busbar, and the temperature estimation unit 140 analyzes this data to estimate the temperature of the busbar. If the estimated temperature exceeds a preset reference temperature, the abnormality detection unit 160 generates a warning signal to provide an immediate notification to the system administrator. This allows for quick detection of thermal problems occurring within the system.

Furthermore, if the reference temperature is set to 70° C. within the battery system, and the temperature estimated by the temperature estimation unit 140 exceeds this value, the abnormality detection unit 160 may generate a visual notification (LED warning display) and an audible alarm. This system may detect overheating problems in advance and take preventive measures such as cooling actions or shutting down the battery system.

The busbar temperature detection apparatus 100 according to an embodiment of the present disclosure may monitor the respective temperature data for one or more busbars in real time, and diagnose the overall thermal state of the battery system.

The EIS measurement unit 120 according to an embodiment of the present disclosure measures the impedance from a plurality of busbars in real time, the temperature estimation unit 140 estimates the real-time temperature of each busbar based on this data, and the abnormality detection unit 160 monitors the temperature of each busbar and can immediately generate a warning signal if the temperature exceeds a reference temperature.

According to an embodiment of the present disclosure, a plurality of busbars installed within a battery system are interconnected current transmission paths, and the thermal state of each busbar has a significant impact on the safe operation of the system. The EIS measurement unit 120 measures the impedance of each busbar through an EIS measurement channel, and through this, the temperature data may be monitored in real time.

The temperature data of each busbar is updated in real time, and the system administrator may comprehensively determine the thermal state of the entire system through this, allowing for immediate detection of temperature changes occurring in a plurality of busbars, thus enabling a quick response before overheating problems occur.

The busbar temperature data collected in real time by the busbar temperature detection apparatus 100 may be used to diagnose the overall thermal state of the battery system. The temperature change across a plurality of busbars indicates the thermal state of a specific region within the battery system, and the busbar temperature detection apparatus 100 may detect thermal problems in the system early by comprehensively analyzing this.

For example, if the temperatures of several busbars located in a specific region rapidly increase, the busbar temperature detection apparatus 100 may diagnose that a heat concentration phenomenon has occurred in that region. Through such a diagnosis, preventive measures such as activating a cooling device or system control can be performed immediately.

As such, the busbar temperature detection apparatus 100 may quickly and accurately diagnose the overall thermal state of the battery system by monitoring the temperature data of each busbar in real time. Through this, the system can detect overheating problems early and take preventive measures, thereby greatly improving the stability and safety of the battery system.

Furthermore, the busbar temperature detection apparatus 100 may immediately determine the temperature change of each busbar through real-time monitoring and may quickly generate a warning signal if a thermal problem occurs. Accordingly, the busbar temperature detection apparatus 100 may identify heat concentration areas through the diagnosis of the overall thermal state of the battery system and, based on this, may implement efficient management and safety measures for the system.

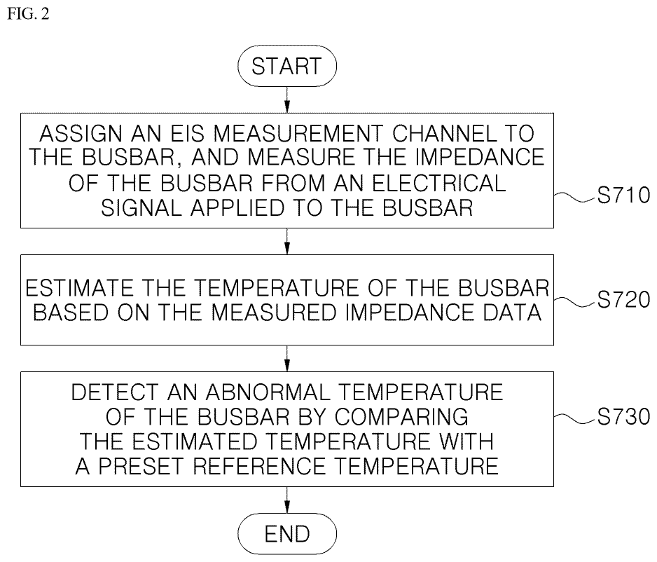

FIG. 2 is a flowchart explaining a method for detecting a busbar temperature using EIS according to an embodiment of the present disclosure.

As shown in FIG. 2, in an embodiment according to another aspect of the present disclosure, a method for detecting a busbar temperature includes: a step of additionally assigning, by an EIS measurement unit, an EIS measurement channel to a busbar formed between a plurality of cells or modules, and measuring the impedance of the busbar using an electrical signal applied to the busbar (S710); a step of estimating, by a temperature estimation unit, the temperature of the busbar based on the measured impedance (S720); and a step of detecting, by an abnormality detection unit, an abnormal temperature of the busbar by comparing the estimated temperature with a preset reference temperature (S730).

In the busbar temperature detection method according to an embodiment of the present disclosure, first, an EIS measurement channel is additionally assigned to a busbar by the EIS measurement unit, and the impedance of the busbar is measured from an electrical signal applied to the busbar(S710).

According to an embodiment of the present disclosure, the EIS measurement unit additionally assigns an EIS measurement channel to a busbar formed between a plurality of cells or modules, and the EIS measurement channel is electrically connected to both ends of the busbar to allow for impedance measurement.

According to an embodiment of the present disclosure, the EIS measurement unit may measure the impedance of the busbar in real time using an electrical signal applied to the busbar. This is because the EIS measurement unit additionally assigns an EIS measurement channel to the busbar, enabling the estimation of the temperature state of the busbar through impedance measurement without a separate temperature sensor.

According to an embodiment of the present disclosure, the EIS measurement unit measures the impedance through the EIS measurement channel, using an electrical signal applied to the busbar. In this process, the EIS measurement unit separates the impedance of the busbar into a real part and an imaginary part to distinguish the resistance component and the inductive component. The real part of the impedance mainly represents the resistance component and plays an important role in temperature estimation.

The busbar temperature detection method according to an embodiment of the present disclosure may include a step of estimating the temperature of the busbar based on the measured impedance (S720).

The measured impedance is transmitted to the temperature estimation unit, which estimates the temperature of the busbar based on the real part of the impedance. The temperature estimation unit performs temperature estimation based on the correlation between impedance and temperature.

This is because the Temperature Coefficient of Resistance varies depending on the material of the busbar, allowing for a more accurate estimation of temperature by combining the impedance and material properties.

The temperature estimation by the temperature estimation unit is performed in real time, and through this, the thermal state of the busbar may be continuously monitored.

The busbar temperature detection method according to an embodiment of the present disclosure may include a step of detecting, by an abnormality detection unit, an abnormal temperature of the busbar by comparing the estimated temperature with a preset reference temperature (S730).

The temperature estimated by the abnormality detection unit is compared with a preset reference temperature, and if the estimated temperature exceeds the reference temperature, the abnormality detection unit determines it as an abnormal temperature and generates a warning signal.

The reference temperature is the maximum allowable temperature set for the safe operation of the system, and an immediate response is required if this temperature is exceeded.

When an abnormal temperature is detected by the abnormality detection unit, a warning signal is transmitted to the system administrator, and a visual or audible warning is provided, thereby preventing system damage due to overheating in advance.

Specifically, the EIS measurement unit electrically connects (assigns) an EIS measurement channel to both ends of the busbar and measures the impedance in real time through the EIS measurement unit. The temperature estimation unit estimates the temperature of the busbar based on the real part of the impedance, and the abnormality detection unit detects an abnormal temperature by comparing the estimated temperature with a preset reference temperature. A warning signal may be generated if the temperature exceeds the reference temperature.

Furthermore, the EIS measurement unit electrically connects (assigns) an EIS measurement channel to each of the two ends of a plurality of busbars and independently measures the impedance of each busbar. The temperature estimation unit estimates the temperature state of the corresponding busbar based on the impedance of each busbar, and the abnormality detection unit detects whether there is a temperature abnormality by comparing it with a reference temperature. If a warning signal is generated, a visual warning system may be activated to provide an immediate notification to the administrator.

As such, the busbar temperature detection method using an EIS measurement channel according to an embodiment of the present disclosure may detect the temperature of the busbar in real time and, through this, may detect thermal problems early. This method may estimate temperature through impedance without a temperature sensor, which enables cost reduction, and may accurately monitor the thermal state of the busbar.

That is, the busbar temperature detection method according to an embodiment of the present disclosure may enhance the safety of the battery system through temperature estimation and abnormality detection, may prevent accidents due to overheating in advance, and may comprehensively diagnose the overall thermal state of the battery system through real-time data collection and accurate temperature estimation.

According to an embodiment of the present disclosure, the step of measuring the impedance of the busbar (S710) may include a step of measuring the impedance by separating it into a real part and an imaginary part, and estimating the temperature based on the real part by the temperature estimation unit.

By measuring the impedance by separating it into a real part and an imaginary part by the EIS measurement unit, the resistance component directly related to temperature may be accurately determined, thereby increasing the accuracy of temperature estimation.

The real part of the impedance represents the resistance component of the busbar and has the characteristic that resistance increases as temperature rises. Therefore, the temperature of the busbar may be estimated by the temperature estimation unit based on the real part measured through the EIS measurement channel by the EIS measurement unit.

The temperature estimation unit calculates the temperature based on the real part and the material properties of the busbar, and in particular, a more accurate temperature estimation is possible by applying the Temperature Coefficient of Resistance.

According to an embodiment of the present disclosure, the step of measuring the impedance of the busbar (S710) may include a step in which the EIS measurement channel is electrically connected to both ends of each busbar, and the impedance of each busbar is individually measured.

That is, the thermal state of each busbar in a battery system may be different, and the state of each busbar may be more accurately determined through individual impedance measurement.

According to an embodiment of the present disclosure, the temperature of a specific region within the battery system can be estimated by measuring the impedance from one or more busbars by the EIS measurement unit, and through the measured impedance by the temperature estimation unit.

A specific region may be defined as a battery module where a plurality of busbars exist or a section including a plurality of cells, and the temperature of the busbar may be estimated by the temperature estimation unit through impedance measurement by the EIS measurement unit, and based on this, the comprehensive thermal state of the specific region may be evaluated. That is, if a plurality of busbars in a specific region show an impedance change, the possibility of a heat concentration phenomenon or a thermal abnormality occurring in that region may be diagnosed.

According to an embodiment of the present disclosure, the impedance measured from one or more busbars by the EIS measurement unit may reflect the temperature state of the region where the busbar is located. That is, the impedance may be individually measured from a plurality of busbars through the EIS measurement channel by the EIS measurement unit, and this may be transmitted to the temperature estimation unit to estimate the temperature of the corresponding region.

That is, the temperature estimation unit estimates the busbar temperature based on the real part of each busbar, and can comprehensively estimate the temperature of a specific region by combining the data of a plurality of busbars.

This method may be useful for increasing system safety by quickly detecting a temperature rise occurring within a specific section and generating a warning signal.

The step of estimating the temperature of the busbar (S720) according to an embodiment of the present disclosure may include a step of estimating the temperature based on the impedance by applying the Temperature Coefficient of Resistance according to the material of the busbar.

According to an embodiment of the present disclosure, the temperature can be estimated based on impedance by applying the Temperature Coefficient of Resistance (TCR) according to the material of the busbar by the temperature estimation unit. The Temperature Coefficient of Resistance is an important physical parameter that describes the characteristic of a specific material's resistance changing with temperature, and the resistance changes with temperature according to the properties of the material.

The Temperature Coefficient of Resistance differs depending on the material of the busbar, which explains the change in resistance with temperature change. For example, materials such as copper or aluminum each have a different Temperature Coefficient of Resistance, and by applying this, the accuracy of temperature estimation can be increased.

According to an embodiment of the present disclosure, the impedance measured through the EIS measurement channel by the EIS measurement unit includes the resistance component of the real part of the busbar, and the temperature estimation unit estimates the temperature by combining this data with the Temperature Coefficient of Resistance for each material. The real part represents the resistance component, which fluctuates with temperature changes.

The temperature estimation unit may more accurately estimate the temperature of the busbar by applying the Temperature Coefficient of Resistance to the real part of the impedance. This is a result that reflects the variation in resistance value with temperature change, which varies depending on the material. By considering the material properties of the busbar, an optimal temperature estimation suitable for each busbar becomes possible.

According to an embodiment of the present disclosure, the step of detecting the abnormal temperature of the busbar (S730) may include a step of generating a warning signal if a temperature exceeding a preset reference temperature is detected.

According to an embodiment of the present disclosure, the abnormality detection unit monitors the temperature of the busbar in real time and, if the estimated temperature exceeds a preset reference temperature, determines it as an abnormal temperature and generates a warning signal. The reference temperature means the maximum allowable temperature set for the system to operate safely. The reference temperature is preset according to the operating conditions of the system and provides a safe temperature range to prevent system damage due to overheating.

According to an embodiment of the present disclosure, the real-time temperature of the busbar estimated by the temperature estimation unit is compared with the reference temperature by the abnormality detection unit. If the estimated temperature exceeds the reference temperature, the abnormality detection unit immediately generates a warning signal. This warning signal may be transmitted to the system administrator in a visual, audible, or electronic manner.

According to an embodiment of the present disclosure, the method for detecting a busbar temperature using EIS may monitor the respective temperature data for one or more busbars in real time by a busbar temperature detection apparatus, and diagnose the overall thermal state of the battery system.

According to an embodiment of the present disclosure, the busbar temperature detection apparatus provides a function that can continuously detect the temperature change of each busbar by monitoring the respective temperature data for one or more busbars in real time, and through this, the thermal state of the busbar can be determined in real time.

As such, according to an embodiment of the present disclosure, the EIS busbar temperature detection method can comprehensively diagnose the overall thermal state of the battery system. By collecting the temperature data of each busbar in real time, it is possible to detect and diagnose thermal problems occurring in a specific section of the battery system.

That is, the temperature data of each busbar becomes an important indicator representing the overall thermal state of the battery system, and through this, areas with a risk of overheating can be identified.

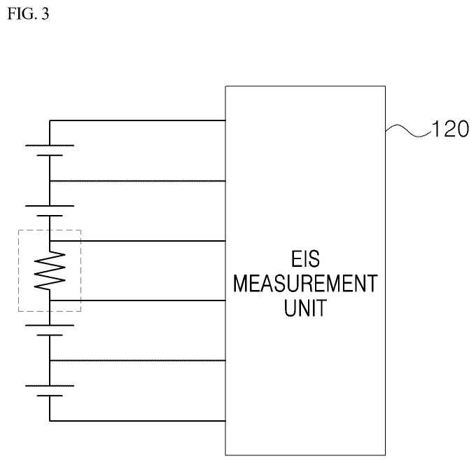

FIG. 3 is a schematic diagram illustrating an example where an EIS measurement channel is additionally assigned to a busbar between cells in a method for detecting a busbar temperature using EIS according to an embodiment of the present disclosure.

As shown in FIG. 3, in a state where the EIS measurement unit 120 is connected to a plurality of cells and busbars through an EIS measurement channel, it aims to measure the impedance of the busbar and track the temperature state through this.

The resistance component representation in FIG. 3, which is the part indicated as a resistor inside the busbar, signifies the real part of the impedance, and since this resistance component changes with the temperature of the busbar, the EIS measurement unit 120 may measure it to determine the thermal state of the busbar.

According to an embodiment of the present disclosure, unlike conventional technology, it is possible to directly estimate the temperature of the busbar only by EIS measurement without the need to attach a temperature sensor to each busbar, which brings about a system cost reduction effect and enables more efficient thermal management.

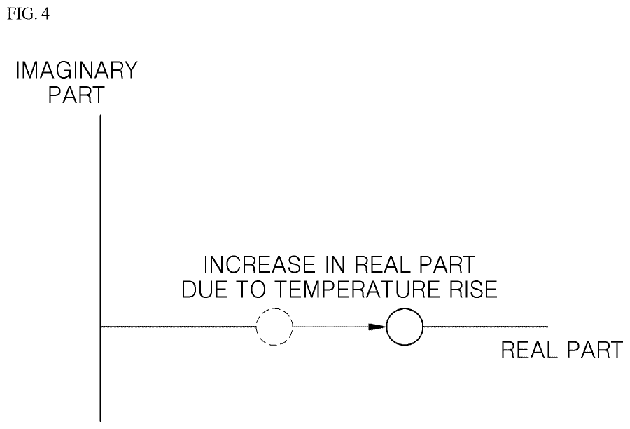

FIG. 4 is a schematic diagram illustrating the correlation between temperature and resistance (the real part of impedance) (a Nyquist plot) according to an embodiment of the present disclosure.

This illustrates the relationship between the real and imaginary parts of impedance. Impedance is an indicator representing electrical characteristics, where the real part (X-axis) mainly represents the resistance component, and the imaginary part (Y-axis) mainly represents the reactance.

As shown in FIG. 4, when the temperature rises, the real part, which is the resistance component, increases, which means an increase in electrical resistance due to heat, and the temperature change may be confirmed through EIS measurement.

As such, the temperature of the busbar may be estimated in real time through the change in the real part value, and a rapid rise in temperature may be detected through impedance measurement, and accordingly, a warning signal may be generated by the abnormality detection unit to prevent thermal problems in advance.

Meanwhile, an EIS measurement apparatus according to an embodiment of another aspect of the present disclosure may include a channel assignment unit (not shown) for assigning an EIS measurement channel corresponding to one or more busbars formed between a plurality of cells or modules, and an EIS measurement unit for measuring the impedance of the busbar using an electrical signal applied to the busbar. In this embodiment, a detailed description of configurations that overlap with the previously described embodiments will be omitted.

The channel assignment unit according to an embodiment of the present disclosure may assign a plurality of EIS measurement channels to each busbar to be electrically connected to a plurality of busbars.

The EIS measurement unit according to an embodiment of the present disclosure may measure the impedance of each busbar through the EIS measurement channel. That is, an EIS measurement channel can be assigned to each of a plurality of busbars by the channel assignment unit, and the impedance of each busbar can be independently measured through the EIS measurement channel by the EIS measurement unit.

Through this, the EIS measurement apparatus according to an embodiment of the present disclosure enables accurate impedance measurement utilizing EIS, and may estimate the temperature of the busbar without using a temperature sensor.

The channel assignment unit according to an embodiment of the present disclosure may assign a unique EIS measurement channel to each busbar, and the EIS measurement unit may simultaneously perform impedance measurements on a plurality of busbars.

By assigning a unique EIS measurement channel to each busbar by the channel assignment unit, the EIS measurement unit may simultaneously perform impedance measurements on a plurality of busbars. Accordingly, the state of all busbars within the battery system can be monitored in parallel, and the state of each busbar can be analyzed simultaneously.

According to an embodiment of the present disclosure, the one or more busbars may include a plurality of busbars, and the EIS measurement channel may be electrically connected to both ends of each of the plurality of busbars to measure the impedance of the plurality of busbars simultaneously or individually.

The EIS measurement channel is electrically connected to both ends of each busbar, and by individually measuring the impedance of each busbar, changes in the electrical characteristics of the busbar can be accurately measured, and independent data collection is possible for a plurality of busbars.

Through this, a temperature rise or an abnormal state in a specific region within the system can be efficiently detected.

The EIS measurement unit according to an embodiment of the present disclosure may measure the impedance of each busbar by separating it into a real part and an imaginary part, and may estimate the temperature of the busbar based on the real part.

The EIS measurement unit analyzes the impedance of the busbar by separating it into a real part and an imaginary part, where the real part represents the resistance component and can be utilized as an indicator for temperature estimation.

As such, the EIS measurement unit may precisely estimate the temperature of the busbar by utilizing the correlation between impedance and temperature, and through this, may diagnose thermal problems in the battery system in advance and prevent problems such as thermal runaway. Furthermore, the imaginary part of the impedance represents reactance and can be utilized for additional electrical characteristic analysis.

The EIS measurement unit according to an embodiment of the present disclosure may estimate the temperature based on the impedance by applying the Temperature Coefficient of Resistance according to the material of the busbar.

The Temperature Coefficient of Resistance is a numerical value of the resistance change according to the temperature change of the busbar material, which can increase the accuracy of temperature estimation.

That is, the EIS measurement unit estimates the temperature by applying the temperature coefficient for each material based on the real part of the impedance, thereby reflecting the temperature change reaction that varies depending on the material of the busbar and increasing the accuracy of temperature estimation.

The EIS measurement apparatus according to an embodiment of the present disclosure may diagnose the overall thermal state of the battery system by analyzing the impedance measured from one or more busbars.

The EIS measurement apparatus may diagnose the thermal state of a specific section within the battery system by analyzing the impedance measured from one or more busbars, and may detect heat concentration areas or abnormal states within the battery system early by integrating the data of a plurality of busbars.

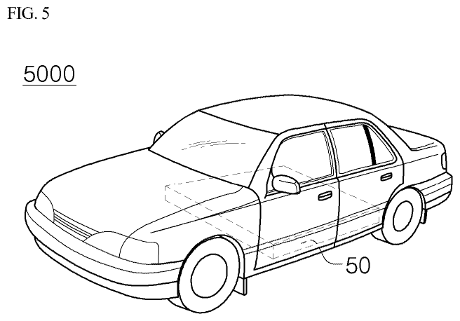

FIG. 5 is a diagram illustrating an electric vehicle including an EIS measurement apparatus or a busbar temperature detection apparatus using EIS, or using a method for detecting a busbar temperature using EIS according to an embodiment of the present disclosure.

Referring to FIG. 5, an electric vehicle 5000 including a busbar temperature detection apparatus or an EIS measurement apparatus using EIS of the present disclosure according to an embodiment may be driven by being supplied with power required for driving an electric motor from a battery pack 50 that may detect an abnormal state of an energy storage device. The electric vehicle 5000 may include the busbar temperature detection apparatus or EIS measurement apparatus using EIS described with reference to FIG. 1 to FIG. 4, although not shown.

Therefore, thermal runaway may be reduced when an abnormal state occurs in the battery pack of the electric vehicle 5000.

Meanwhile, the electric vehicle 5000 according to an embodiment of the present disclosure may further include a control system (e.g., an ECU (Electronic Control Unit)) that communicates with a battery management system in a designated communication method (e.g., CAN (Control Area Network)), at least one display that provides (e.g., displays) various information of the electric vehicle 5000 (e.g., state information of the battery pack or cells included in the battery pack, abnormal state information and impedance, temperature information detected according to the busbar temperature detection apparatus or EIS measurement apparatus using EIS according to the present disclosure, a warning signal according to abnormal temperature detection, driving information of the electric vehicle 5000, etc.).

Furthermore, it may be applied to various devices that operate by receiving power from a battery module or battery pack 50, whose abnormal state may be monitored by the busbar temperature detection method and apparatus, and EIS measurement apparatus using EIS according to an embodiment of the present disclosure. For example, the busbar temperature detection apparatus or EIS measurement apparatus using EIS according to an embodiment of the present disclosure may be applied to an electric mobility device (e.g., a hybrid vehicle, an electric bicycle, an electric motorcycle, etc.), an Energy Storage System (ESS), and the like.

Various embodiments of the present disclosure may be implemented as software (e.g., a program) including one or more instructions stored in a machine-readable storage medium (e.g., an internal memory or an external memory). For example, a processor of a machine (e.g., an electronic device) may call at least one command among one or more instructions stored from the storage medium and execute it. This enables the machine to be operated to perform at least one function according to the called at least one command. The one or more instructions may include code generated by a compiler or code that may be executed by an interpreter. The machine-readable storage medium may be provided in the form of a non-transitory storage medium. Here, ‘non-transitory’ only means that the storage medium is a tangible device and does not include a signal (e.g., an electromagnetic wave), and this term does not distinguish between cases where data is stored semi-permanently in the storage medium and cases where it is stored temporarily.

A method according to various embodiments of the present disclosure may be included and provided in a computer program product. A computer program product may be traded between a seller and a buyer as a commodity. A computer program product may be distributed in the form of a machine-readable storage medium (e.g., a compact disc read only memory (CD-ROM)), or may be distributed online (e.g., downloaded or uploaded) through an application store (e.g., Play Store™) (or directly between two user devices (e.g., smartphones)). In the case of online distribution, at least a part of the computer program product may be at least temporarily stored or temporarily generated in a machine-readable storage medium such as a memory of a manufacturer's server, an application store's server, or a relay server.

The foregoing is merely an example of applying the principles of the present disclosure, and other configurations may be further included without departing from the scope of the present disclosure. For example, at least some of the various embodiments of the present disclosure described above may be combined.

What is claimed is:

1. A busbar temperature detection apparatus using EIS, comprising:
an EIS measurement unit configured to assign an EIS measurement channel to a busbar formed between a plurality of cells or modules, and to measure impedance using an electrical signal applied to the busbar;
a temperature estimation unit configured to estimate the temperature of the busbar based on the impedance measured by the EIS measurement unit; and
an abnormality detection unit configured to detect an abnormal temperature of the busbar by comparing the temperature estimated by the temperature estimation unit with a preset reference temperature.

2. The apparatus of claim 1, wherein the EIS measurement unit measures the impedance of the busbar by separating it into a real part and an imaginary part, and the temperature estimation unit estimates the temperature based on the real part.

3. The apparatus of claim 1, wherein the EIS measurement channel is electrically connected to both ends of each busbar, and the EIS measurement unit individually measures the impedance of each busbar through the EIS measurement channel.

4. The apparatus of claim 3, wherein the temperature estimation unit estimates the temperature of a specific region within a battery system through the impedance measured from one or more busbars.

5. The apparatus of claim 1, wherein the temperature estimation unit estimates the temperature based on the impedance by applying a Temperature Coefficient of Resistance according to a material of the busbar.

6. The apparatus of claim 1, wherein the abnormality detection unit generates a warning signal if a temperature exceeding a preset reference temperature is detected.

7. The apparatus of claim 1, wherein the apparatus is configured to monitor respective temperature data for one or more busbars in real time, and diagnose an overall thermal state of a battery system.

8. A method for detecting a busbar temperature using EIS, comprising:
assigning, by an EIS measurement unit, an EIS measurement channel to a busbar formed between a plurality of cells or modules, and measuring an impedance of the busbar using an electrical signal applied to the busbar;
estimating, by a temperature estimation unit, a temperature of the busbar based on the measured impedance; and
detecting, by an abnormality detection unit, an abnormal temperature of the busbar by comparing the estimated temperature with a preset reference temperature.

9. The method of claim 8, wherein the measuring the impedance of the busbar comprises measuring the impedance by separating it into a real part and an imaginary part, and estimating the temperature based on the real part.

10. The method of claim 8, wherein the measuring the impedance of the busbar comprises the EIS measurement channel being electrically connected to both ends of each busbar and individually measuring the impedance of each busbar.

11. The method of claim 10, comprising measuring the impedance from one or more busbars by the EIS measurement unit, and estimating a temperature of a specific region within a battery system through the measured impedance by the temperature estimation unit.

12. The method of claim 8, wherein the estimating the temperature of the busbar comprises estimating the temperature based on the impedance by applying a Temperature Coefficient of Resistance according to a material of the busbar.

13. The method of claim 8, wherein the detecting the abnormal temperature of the busbar comprises generating a warning signal if a temperature exceeding a preset reference temperature is detected.

14. The method of claim 8, wherein the method for detecting a busbar temperature using EIS monitors respective temperature data for one or more busbars in real time, and diagnoses an overall thermal state of a battery system.

15. An EIS measurement apparatus, comprising:
a channel assignment unit configured to assign an EIS measurement channel corresponding to one or more busbars formed between a plurality of cells or modules; and
an EIS measurement unit configured to measure an impedance of the busbar using an electrical signal applied to the busbar.

16. The apparatus of claim 15, wherein the one or more busbars comprise a plurality of busbars, and
the EIS measurement channel is electrically connected to both ends of each of the plurality of busbars to measure the impedance of the plurality of busbars simultaneously or individually.

17. The apparatus of claim 15, wherein the EIS measurement unit measures the impedance of the busbar by separating it into a real part and an imaginary part, and estimates a temperature of the busbar based on the real part.

18. The apparatus of claim 15, wherein the EIS measurement unit estimates a temperature based on the impedance by applying a Temperature Coefficient of Resistance according to a material of the busbar.
